(19) United States
(12) Patent Application Publication
(10) Pub. No.: US 2007/0149696 A1
(43) Pub. Date: Jun. 28, 2007

(54) Aqueous dispersions of copolymers production thereof and use of the same

(75) Inventors: Stephan Hueffer, Ludwigshafen (DE); Darijo Mijolovic, Mannheim (DE); Peter Danisch, Ludwigshafen (DE); Matthias Kluglein, Ludwigshafen (DE); Gunther Pabst, Neumarkt (DE); Gerhard Wolf, Ketsch (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Basf Aktiengesellschaft, Ludwigshafen (DE)

(21) Appl. No.: 10/573,708

(22) PCT Filed: Sep. 18, 2004
(86) PCT No.: PCT/EP04/10491

§ 371 Date: Mar. 27, 2006

(30) Foreign Application Priority Data
Sep. 26, 2003 (DE) 10345094.7
Nov. 14, 2003 (DE) 10353557.8
Nov. 25, 2003 (DE) 10355402.5

(51) Int. Cl. C08F 222/40

(52) U.S. Cl. 524/548

(57) ABSTRACT

Aqueous dispersions of copolymers are obtainable by free radical copolymerization of (A) at least one ethylenically unsaturated dicarboxylic anhydride, derived from at least one dicarboxylic acid of 4 to 8 carbon atoms,
(B) at least one oligomer of branched or straight-chain C₃-C₁₀-alkene, at least one oligomer having an average molecular weight Mₙ of from 300 to 5 000 g/mol or being obtainable by oligomerization of at least 3 equivalents of C₃-C₁₀-alkene, (C) optionally at least one ethylenically unsaturated comonomer differing from (A), and optionally reaction with
   (D) at least one compound of the formula I a or I b 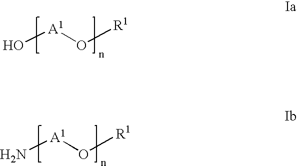 and subsequent addition of water, where, in formulae I a and I b,
A¹ are identical or different C₂-C₂₀-alkylene,
R¹ is linear or branched C₁-C₃₀-alkyl, phenyl or hydrogen, and n is an integer from 1 to 200, the water content being from 30 to 99.5% by weight, based on aqueous dispersion.

The present invention relates to aqueous dispersions of copolymers, obtainable by free radical copolymerization of
(A) at least one ethylenically unsaturated dicarboxylic anhydride, derived from at least one dicarboxylic acid of 4 to 8 carbon atoms,
(B) at least one oligomer of branched or straight-chain C₃-C₁₀-alkene, at least one oligomer having an average molecular weight Mₙ, of from 300 to 5 000 g/mol or being obtainable by oligomerization of at least 3 equivalents of C₃-C₁₀-alkene,
(C) optionally at least one ethylenically unsaturated comonomer differing from (A),
   and optionally reaction with
(D) at least one compound of the formula I a or I b 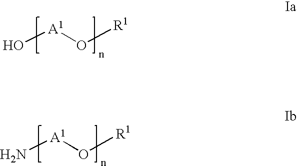
   and subsequent addition of water,
where, in formulae I a and I b,
A¹ are identical or different C₂-C₂₀-alkylene,
R¹ are linear or branched C₁-C₃₀-alkyl, phenyl or hydrogen, and
   n is an integer from 1 to 200,
   the water content being from 30 to 99.5% by weight, based on aqueous dispersion.

The present invention furthermore relates to a process for the preparation of novel aqueous dispersions and their use for the treatment of fibrous substrates.

The present invention furthermore relates to copolymers obtainable by free radical copolymerization of
(A) at least one ethylenically unsaturated dicarboxylic anhydride, derived from at least one dicarboxylic acid of 4 to 8 carbon atoms,
(B) at least one oligomer of branched or straight-chain C₃-C₁₀-alkene, at least one oligomer having an average molecular weight Mₙ, of from 300 to 5 000 g/mol and being obtainable by oligomerization of at least 3 equivalents of C₃-C₁₀-alkene,
(C) optionally at least one ethylenically unsaturated comonomer differing from (A),
   and optionally reaction with
(D) at least one compound of the formula I a or I b 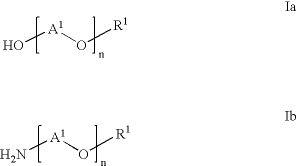
   where, in the formulae I a and I b, the variables are defined as above.

In the production of leather, the imparting of water repellency to protect the leather or a leather article from moisture and dirt plays an important role in addition to performance characteristics such as softness and body. Further performance characteristics of the leather, for example the handle, are also influenced by the type of water repellency imparted. However, in the case of other fibrous substrates too, for example textile, paper, board, artificial leather and wood, the imparting of water repellency plays an important role. Impregnation is an important field of work also in the case of sheet-like substrates, for example of concrete and of bricks.

WO 95/07944 discloses copolymers of from 20 to 60 mol % of monoethylenically unsaturated C₄-C₆-dicarboxylic acids or anhydrides thereof with from 10 to 70 mol % of at least one oligomer of propene or of a branched 1-olefin, for example isobutene, and from 1 to 50 mol % of at least one monoethylenically unsaturated compound which is polymerizable with the abovementioned monomers, for example vinyl and alkyl allyl ethers, and the use thereof for the preparation of oil-soluble reaction products which are suitable as an additive for lubricants and fuels.

WO 90/03359 and EP-A 0 657 475 disclose alternating copolymers of maleic anhydride and polyisobutene, which, after modification with amines or polyamines, can be used as an additive in lubricants and fuels.

WO 01/55059 discloses terpolymers of maleic anhydride, one or more olefins of more than 40 carbon atoms, for example polyisobutene, and a vinyl ester of carboxylic acids of 2 to 12 carbon atoms, and the use of the terpolymers as emulsifiers for explosives.

WO 03/23070 discloses fatliquoring agents for hides, which fatliquoring agents comprise, for example, polyisobutene or products which are prepared by an ene reaction from polyisobutene and suitable enophiles (page 6, line 29 et seq.).

It is an object of the present invention to provide water repellents for fibrous substrates, which permit good protection from moisture and at the same time a pleasant handle of the water-repellent substrates. It is a further object of the present invention to provide a process for the preparation of water repellents, and it is an object of the present invention to provide a process for imparting water repellency to fibrous substrates using novel water repellents.

We have found that these objects are achieved by the aqueous dispersions of copolymers, defined at the outset.

Below, dispersions of copolymers are understood as meaning emulsions, suspensions and also clear solutions of copolymers.

Novel aqueous dispersions comprise a copolymer which is obtainable by free radical copolymerization of
(A) at least one ethylenically unsaturated dicarboxylic anhydride, derived from at least one dicarboxylic acid of 4 to 8 carbon atoms, for example maleic anhydride, itaconic anhydride, citraconic anhydride, or methylenemalonic anhydride, preferably itaconic anhydride or maleic anhydride, very particularly preferably maleic anhydride;
(B) at least one oligomer of branched or straight-chain C₃-C₁₀-alkene, at least one oligomer having an average molecular weight Mₙ of from 300 to 5 000 g/mol or being obtainable by oligomerization of at least 3 equivalents of C₃-C₁₀-alkene,
   and
(C) optionally at least one ethylenically unsaturated comonomer differing from (A),
   which are optionally reacted with
(D) at least one compound of the formula I a or I b, preferably I a 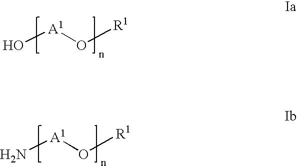
   where
A¹ is C₂-C₂₀-alkylene, for example —(CH₂)₂—, —CH₂—CH(CH₃)—, —(CH₂)₃—, —CH₂—CH(C₂H₅)—, —CH₂—CH(iso-C₃H₇)—, —CH₂—CH(n-C₄H₉) —, —(CH₂)₄—, —(CH₂)₅—, —(CH₂)₆—, preferably C₂-C₄-alkylene, in particular —(CH₂)₂—, —CH₂—CH(CH₃)—and —CH₂—CH(C₂H₅)—,
R₁ is phenyl, hydrogen
   or preferably linear or branched C₁-C₃₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl, n-hexadecyl, n-octadecyl and n-eicosyl, particularly preferably C₁-C₄-alkyl, such as methyl, ethyl, n-propyl, isopropyl, n-butyl, isobutyl, sec-butyl and tert-butyl, very particularly preferably methyl, and
   n is an integer from 1 to 200, preferably from 4 to 50.

The groups A¹ can of course differ only when n is greater than 1 or when different compounds of the formula (D) are used.

In an embodiment of the present invention, mixtures of different components (D), for example of the formula I a, are used. In particular, it is possible to use mixtures of compounds of the formula I a in which—based in each case on the mixture—at least 95, preferably at least 98, mol % to not more than 99.8 mol % of R¹ are C₁-C₃₀-alkyl and at least 0.2 to not more than 5, preferably not more than 2, mol % are hydrogen.

In an embodiment of the present invention, water is added after the free radical copolymerization and, if appropriete, the reaction with (D), it being possible for the Water also to comprise Brøonsted acid or preferably Brøonsted base. Examples of Brøonsted acids are sulfuric acid, hydrochloric acid, tartaric acid and citric acid. Examples of Brøonsted bases are alkali metal hydroxide, for example NaOH and KOH, alkali metal carbonate, for example Na₂CO₃ and K₂CO₃, alkali metal bicarbonate, for example NaHCO₃ and KHCO₃, ammonia, and amines, for example trimethylamine, triethylamine, diethylamine, ethanolamine, N,N-diethanolamine, N,N,N-triethanolamine and N-methylethanolamine.

In another embodiment of the present invention, water may be added during the free radical copolymerization itself.

Novel dispersions have a water content of from 30 to 99.5, preferably from 60 to 90, % by weight, based on the total weight of the novel dispersion.

Suitable comonomers (B) are oligomers of propylene or straight-chain or preferably branched C₄-C₁₀-olefins, at least one oligomer having an average molecular weight Mₙ of from 300 to 5 000 g/mol or being obtainable by oligomerization of at least 3, preferably at least 4, equivalents of C₃-C₁₀-alkene. Examples are oligomers of propylene, isobutene, 1-pentene, 2-methylbut-1-ene, 1-hexene, 2-methylpent-1-ene, 2-methylhex-1-ene, 2-ethylpent-1-ene, 2-ethylhex-1-ene and 2-propylhept-1-ene, 1-octene and 1-decene, very particularly preferably isobutene. Comonomers (B) have an ethylenically unsaturated group which may be present in the form of a vinyl, vinylidene or alkylvinylidene group.

Co-oligomers of the abovementioned olefins with one another or with up to 20% by weight, based on (B), of vinylaromatics, such as styrene and a-methylstyrene, C₁-C₄-alkylstyrene, such as 2-, 3- and 4-methylstyrene and 4-tert-butylstyrene, are also suitable.

Particularly preferred comonomers (B) are oligopropylenes and oligoisobutenes having an average molecular weight Mₙ of from 300 to 5 000, preferably from 400 to 3 000, particularly preferably from 500 to 2 300, very particularly preferably from 550 to 1 200, especially up 1 000, g/mol, for example determined by means of gel permeation chromatography (GPC). Particularly preferred oligoisobutenes and oligopropylenes are furthermore those which are obtainable by oligomerization of at least 3, preferably at least 4, equivalents of C₃-C₁₀-alkene.

In an embodiment of the present invention, comonomers (B) have a polydispersity of 1.1 to 10, preferably up to 3, and particularly preferably from 1.5 to 1.8.

In an embodiment of the present invention, comonomers (B) have a polydispersity M_{w}/Mₙ, of from 1.1 to 3, preferably froml.5 to 1.8.

In a special embodiment of the present invention, oligomer (B) has a bimodal molecular weight distribution with a maximum of Mₙ in the range from 500 to 1 200 g/mol and a local maximum of Mₙ in the range 2 000 to 5 000 g/mol.

Oligopropylenes and oligoisobutenes are known as such, and oligoisobutenes are obtainable, for example, by oligomerization of isobutene in the presence of a boron trifluoride catalyst, cf. for example DE-A 27 02 604. Suitable isobutene-containing starting materials are both isobutene itself and isobutene-containing C₄-hydrocarbon streams, for example refined C₄ fractions, C₄ cuts from isobutane dehydrogenation, C₄ cuts from steam crackers or FCC crackers (FCC: fluid catalyzed cracking), provided that relevant C₄ cuts have been substantially freed from 1,3-butadiene present therein. The concentration of isobutene in the C₄-hydrocarbon streams is typically from 40 to 60% by weight. Suitable C₄-hydrocarbon streams should as a rule comprise less than 500, preferably less than 200, ppm of 1,3-butadiene.

The preparation of further oligomers (B) is known per se; methods are to be found, for example, in WO 96/23751 and in WO 99/67347, example 3.

Particular examples of compounds of the formula I a are
polyethylene glycols of the formula HO—(CH₂CH₂O)ₘ—CH₃, where m=1 to 200,preferably 4 to 100, particularly preferably 4-50, which have been blocked with methyl terminal groups,
block copolymers of ethylene oxide, propylene oxide and/or butylene oxide which have been blocked with methyl terminal groups and have a molecular weight Mₙ of from 300 to 5 000 g/mol,
random copolymers of ethylene oxide, propylene oxide and/or butylene oxide which have been blocked with methyl terminal groups and have a molecular weight Mₙ of from 300 to 5 000 g/mol,
alkoxylated C₂- to C₃₀-alcohols, in particular fatty alcohol alkoxylates, oxo alcohol alkoxylates or Guerbet alcohol alkoxylates, it being possible for the alkoxylation to be carried out with ethylene oxide, propylene oxide and/or butylene oxide; examples are
C₁₃-C₁₅-oxo alcohol ethoxylates having 3 to 30 ethylene oxide units,
C₁₃-oxo alcohol ethoxylates having 3 to 30 ethylene oxide units,
C₁₂-C₁₄-fatty alcohol ethoxylates having 3 to 30 ethylene oxide units,
C₁₀-oxo alcohol ethoxylates having 3 to 30 ethylene oxide units,
C₁₀-Guerbet alcohol ethoxylates having 3 to 30 ethylene oxide units,
C₄-C₂₀-alcohol ethoxylates having 2 to 20 ethylene oxide units, 2 to 20 propylene oxide units and/or 1 to 5 butylene oxide units,
C₉-C₁₁-oxo alcohol alkoxylates having 2 to 20 ethylene oxide units, 2 to 20 propylene oxide units and/or 1 to 5 butylene oxide units,
C₁₃-C₁₅-oxo alcohol alkoxylates having 2 to 20 ethylene oxide units, 2 to 20 propylene oxide units and/or 1 to 5 butylene oxide units,
C₄-C₂₀-alcohol ethoxylates having 2 to 20 ethylene oxide units.

Preferred examples of compounds of the formula I b are polyethyleneglycolamines of the formula H₂N—(CH₂CH₂O)ₘ—CH₃, where m=1 to 200, preferably 4 to 100, particularly preferably 4 to 50, which have been blocked with methyl terminal groups.

The monomer or monomers (C) which may optionally be copolymerized in the copolymers present in the novel dispersions, differ from (A). Examples of preferred monomers (C) are:

C₃-C₈-carboxylic acid derivatives of the formula II 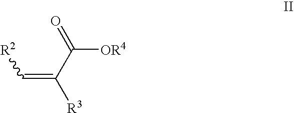
carboxamides of the formula III 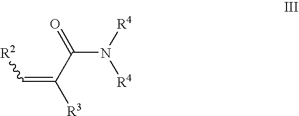
acyclic amides of the formula IV a and cyclic amides of the formula IV b

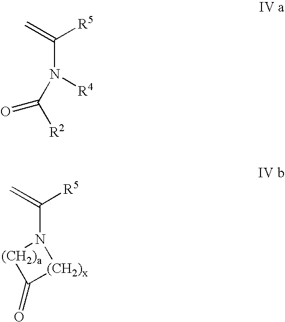

C₁-C₂₀-alkyl vinyl ethers, such as methyl vinyl ether, ethyl vinyl ether, n-propyl vinyl ether, isopropyl vinyl ether, n-butyl vinyl ether, isobutyl vinyl ether, 2-ethylhexyl vinyl ether or n-octadecyl vinyl ether;

N-vinyl derivatives of nitrogen-containing aromatic compounds, preferably N-vinylimidazole, 2-methyl-1-vinylimidazole, N-vinyloxazolidone, N-vinyltriazole, 2-vinylpyridine, 4-vinylpyridine, 4-vinylpyridine N-oxide, N-vinylimidazoline or N-vinyl-2-methylimidazoline;

α,β-unsaturated nitriles, for example acrylonitrile or methacrylonitrile;
alkoxylated unsaturated ethers of the formula V 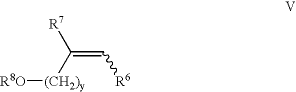
esters and amides of the formula VI 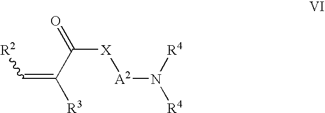
unsaturated esters of the formula VII

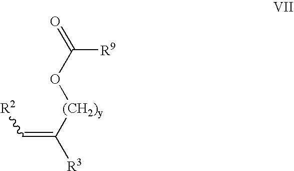

comonomers containing phosphate, phosphonate, sulfate and sulfonate groups, for example [2{(meth)acryloyloxy}ethyl] phosphate or 2-(meth)acrylamido-2-methyl-1-propanesulfonic acid;

linear or branched α-olefins of 3 to 40, preferably 4 to 24, carbon atoms, in particular isobutene, diisobutene, 1-decene, 1-dodecene, 1-octadecene, 1-eicosane, α-C₂₂H44, α-C₂₄H₄₈ and mixtures of the abovementioned α-olefins;
vinylaromatic compounds, for example of the formula VIII 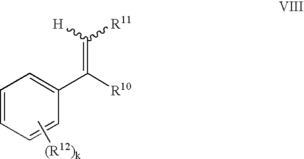
where
A² and A³ are identical or different and are C₂-C₂₀-alkylene, for example —(CH₂)₂—, —CH₂—CH(CH₃)—, —(CH₂)₃—, —CH₂—CH(C₂H₅)—, —CH₂—CH(iso-C₃H₇)—, —CH₂—CH(n-C₄H₉)—, —(CH₂)₄—, —(CH₂)₅—, —(CH₂)6—, preferably C₂-C₄-alkylene, in particular —(CH₂)₂—, —CH₂—CH(CH₃)—and —CH₂—CH(C₂H₅)—;
R² and R³ are identical or different and are selected from straight-chain or branched C₁-C₅-alkyl, such as methyl, ethyl, n-propyl, isopropyl, n-butyl, isobutyl, secbutyl, tert-butyl, n-pentyl, isopentyl, sec-pentyl, neopentyl, 1,2-dimethylpropyl or isoamyl, particularly preferably C₁-C₄-alkyl, such as methyl, ethyl, n-propyl, isopropyl, n-butyl, isobutyl, sec-butyl and tert-butyl;
   and in particular hydrogen;
R⁴ are identical or different and are branched or straight-chain C₁-C22-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl or n-eicosyl; particularly preferably C₁-C₄-alkyl, such as methyl, ethyl, n-propyl, isopropyl, n-butyl, isobutyl, sec-butyl and tert-butyl;
   or particularly preferably hydrogen;
R⁵ is hydrogen or methyl;
x is an integer from 2 to 6, preferably from 3 to 5;
y is an integer selected from 0 and 1, preferably 1;
a is an integer from 0 to 6, preferably from 0 to 2;
b is an integer from 1 to 200, preferably from 4 to 50;
R⁶ and R⁷ are identical or different and are selected from hydrogen and straight-chain or branched C₁-C₁₀-alkyl, straight-chain and branched C₁-C₁₀-alkyl being defined as above;
X is oxygen or N-R⁴;
R⁸ is [A³-O]_{b}-R⁴;
R⁹ is selected from straight-chain or branched C₁-C₂₀-alkyl, such as methyl, ethyl, n-propyl, isopropyl, n-butyl,-isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl, n-tetradecyl, n-hexadecyl, n-octadecyl or n-eicosyl; preferably C₁-C₁₄-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl or n-tetradecyl;
   and in particular hydrogen or methyl;
R¹⁰ and R¹¹, independently of one another, are each hydrogen, methyl or ethyl and R¹⁰ and R¹¹ are preferably each hydrogen;
R¹² is methyl or ethyl;
k is an integer from 0 to 2, preferably 0.

The other variables are defined as above.

Compounds of the formula III which are selected by way of example are (meth)acrylamides, such as acrylamide, N-methylacrylamide, N,N-dimethylacrylamide, N-ethylacrylamide, N-propylacrylamide, N-tert-butylacrylamide, N-tert-octylacrylamide, N-undecylacrylamide or the corresponding methacrylamides.

Compounds of the formula IV a which are selected by way of example are N-vinylcarboxamides, such as N-vinylformamide, N-vinyl-N-methylformamide, N-vinylacetamide or N-vinyl-N-methylacetamide; typical compounds of the formula IV b which are selected by way of example are N-vinylpyrrolidone, N-vinyl-4-piperidone and N-vinyl-ε-caprolactam.

Compounds of the formu VI which are selected by way of example are (meth)acrylates and (meth)acrylamides, such as N,N-dialkylaminoalkyl (meth)acrylates or N,N-dialkylaminoalkyl (meth)acrylamides; examples are N,N-dimethylaminoethyl acrylate, N,N-dimethylaminoethyl methacrylate, N,N-diethylaminoethyl acrylate, N,N-diethylaminoethyl methacrylate, N,N-dimethylaminopropyl acrylate, N,N-dimethylaminopropyl methacrylate, N,N-diethylaminopropyl acrylate, N,N-diethylaminopropyl methacrylate, 2-(N,N-dimethylamino)ethylacrylamide, 2-(N,N-dimethylamino)ethylmethacrylamide, 2-(N, N-diethylamino)ethylacrylamide, 2-(N, N-diethylamino)ethylmethacrylamide, 3-(N,N-dimethylamino)propylacrylamide and 3-(N,N-dimethylamino)propylmethacrylamide.

Compounds of the formula VII which are selected by way of example are vinyl acetate, allyl acetate, vinyl propionate, vinyl butyrate, vinyl 2-ethylhexanoate or vinyl laurate.

The following are very particularly preferably used as comonomer (C): styrene, acrylic acid, diisobutene, 1-dodecene, 1-eicosene, a-C₂₂H₄₄, α-C₂₄H₄₈, methacrylic acid, methyl acrylate, methyl methacrylate, acrylamide, vinyl n-butyl ether, vinyl isobutyl ether, N-vinylformamide, N-vinylpyrrolidone, 1-vinylimidazole and 4-vinylpyridine.

In relation to (A), (B) and, if appropriate, (C), copolymers present in the novel dispersions may be block copolymers, alternating copolymers or random copolymers, alternating copolymers being preferred.

In an embodiment of the present invention, some or all of the anhydride groups of the copolymer are present in hydrolyzed and, if appropriate, neutralized form after the polymerization.

In an embodiment of the present invention, the molar ratios of copolymer dispersed in he novel aqueous dispersions are
(A) from 5 to 60, preferably from 10 to 55, mol %,
(B) from 1 to 95, preferably from 10 to 60, mol %,
(C) from 0 to 70, preferably from 1 to 50, mol %, based in each case on copolymer, the sum of (A), (B) and (C) being 100 mol %, and
(D) from 0 to 50, preferably from 1 to 30, particularly preferably from 2 to 20, mol %, based on all carboxyl groups of the copolymer.

In an embodiment of the present invention, novel aqueous dispersions have a pH of from 3 to 10, preferably from 5 to 8.

In an embodiment of the present invention, copolymers dispersed in novel aqueous dispersions have an average molar mass M_{w}, of from 1 000 to 50 000, preferably from 1 100 to 25 000, g/mol, determined, for example, by the size exclusion chromatography method using, for example, tetrahydrofuran or dimethylacetamide as a solvent and polymethyl methacrylate or polystyrene as a standard.

In an embodiment of the present invention, the polydispersity M_{w},/Mₙ of copolymer dispersed in novel dispersions is in general from 1.1 to 20, preferably from 1.5 to 10.

In an embodiment of the present invention, novel aqueous dispersions may comprise comonomers (B) not incorporated in the form of polymerized units, for example in amounts of from 1 to 30% by weight, based on the total weight of novel aqueous dispersion.

The present invention furthermore relates to a process for the preparation of novel aqueous dispersions, also referred to below as novel preparation process.

For carrying out the novel preparation process, (A), (B) and, if appropriate, (C) are used as starting materials and are subjected to free radical copolymerization with one another. Water is added during or, preferably, after the copolymerization, so that the water content of the novel dispersion is from 30 to 99.5% by weight.

In an embodiment of the present invention, (A), (B) and, if appropriate, (C) are used as starting materials and are subjected to free radical copolymerization with one another and reacted with (D). Water is added during or, preferably, after copolymerization, so that the water content of the novel dispersion is from 30 to 99.5% by weight.

In a special embodiment of the present invention, first a free radical copolymerization of (A), (B) and, if appropriate, (C) is carried out and then reaction with (D) is effected.

In another special embodiment of the present invention, the free radical copolymerization of (A), (B) and, if appropriate, (C) is carried out in the presence of the total amount or portions of the compound (D) to be used.

In another special embodiment of the present invention, first (A) and, if appropriate, (C) are reacted with (D) and then free radical copolymerization is effected.

If a reaction of a copolymer with (D) or a free radical copolymerization in the presence of (D) is desired, the total amount of (D) is then calculated so that complete conversion of (D) is assumed and up to 50, preferably from 1 to 30, particularly preferably from 2 to 20, mol %, based on all carboxyl groups of the copolymer, of (D) are used. In the context of the present invention, the term “all carboxyl groups present in the polymer” is to be understood as meaning those carboxyl groups from polymerized comonomers (A) and, if appropriate, (C) which are present as anhydride, as C₁-C₄-alkyl ester or as carboxylic acid.

The free radical copolymerization is advantageously initiated by means of initiators, for example peroxides or hydroperoxides. Examples of peroxides or hydroperoxides are di-tert-butyl peroxide, tert-butyl peroctanoate, tert-butyl perpivalate, tert-butyl per-2-ethylhexanoate, tert-butyl permaleate, tert-butyl perisobutyrate, benzoyl peroxide, diacetyl peroxide, succinyl peroxide, p-chlorobenzoyl peroxide and dicyclohexyl peroxodicarbonate. The use of redox initiators is also suitable, for example combinations of hydrogen peroxide or sodium peroxodisulfate or one of the abovementioned peroxides with a reducing agent. Examples of suitable reducing agents are ascorbic acid, tartaric acid, Fe(ll) salts, such as FeSO₄, sodium bisulfite and potassium bisulfite.

Suitable initiators are furthermore azo compounds, such as 2,2′-azobisisobutyronitrile, 2,2′-azobis(2-methylpropionamidine) dihydrochloride and 2,2′-azobis(4-methoxy-2,4-dimethylvaleronitrile).

In general, initiator is used in amounts of from 0.1 to 20, preferably from 0.2 to 15, % by weight, based on the mass of all comonomers.

The novel preparation process can be carried out in the presence or absence of solvents and precipitating agents. Suitable solvents for the free radical copolymerization are polar solvents inert to acid anhydride, e.g. acetone, tetrahydrofuran and dioxane. Suitable precipitating agents are, for example, toluene, ortho-xylene, meta-xylene and aliphatic hydrocarbons.

A preferred embodiment is carried out in the absence of solvent or in the presence of only small amounts of solvent, i.e. from 0.1 to not more than 10% by weight, based on the total mass of comonomers (A), (B) and, if appropriate, (C). Solvents are to be understood as meaning substances which are inert under the conditions of the copolymerization and of the esterification or amide formation, in particular aliphatic and aromatic hydrocarbons, such as cyclohexane, n-heptane, isododecane, benzene, toluene, ethylbenzene, xylene as an isomer mixture, meta-xylene or ortho-xylene. If the reaction with (D) is carried out in the absence of acidic catalysts or the reaction with (D) is dispensed with, the free radical copolymerization and, if appropriate, reaction with (D) can also be carried out in solvents selected from ketones, such as acetone or methyl ethyl ketone, or cyclic or acyclic ethers, such as tetrahydrofuran or di-n-butyl ether.

The novel preparation process is preferably carried out in the absence of oxygen, for example in a nitrogen or argon atmosphere, preferably in a nitrogen stream.

Conventional apparatuses may be used for the novel preparation process, e.g. autoclaves and kettles.

The sequence of the addition of the comonomers can be implemented in various ways.

In an embodiment of the novel process, a mixture of (D) and (A) is initially taken and initiator and simultaneously (B) and, if appropriate, (C) are added. It is preferable to add (B) and, if appropriate, (C) by a feed method.

In an embodiment of the present invention, a mixture of (D) and (A) is initially taken and initiator and simultaneously (B) and, if appropriate, (C) are added by a feed method, initiator (B) and, if appropriate, (C) each being dissolved in (D).

In an embodiment of the present invention, a mixture of (D) and (A) is initially taken and initiator and (B) and (C) are added by a feed method, the feed rates of (B) and (C) being chosen to be different.

In another embodiment of the present invention, a mixture of (D) and (A) is initially taken and initiator and (B) and (C) are added by a feed method, the feed rates of (B) and (C) being chosen to be the same.

In another embodiment of the present invention, (B) and, if appropriate, (C) are initially taken and initiator and (A) are added by a feed method and then, if appropriate, reacted with (D).

In another embodiment of the present invention, (B) is initially taken and initiator, (A) and, if appropriate, (C) are added by a feed method and then, if appropriate, reacted with (D).

In another embodiment of the present invention, (A), (B) and, if appropriate, (D) are initially taken and initiator and (C) are added by a feed method. (A), (B) and, if appropriate, (D) can also be initially taken in a solvent. In an embodiment of the present invention, further initiator is added during the addition of (B) and, if appropriate, (C).

In an embodiment of the present invention, the temperature for the copolymerization of (A), (B) and, if appropriate, (C) is from 80 to 300°C., preferably from 100 to 200° C. The pressure is, for example, from 1 to 10, preferably from 1 to 5, bar.

It is possible to use regulators, for example C₁- to C₄-alkylaldehydes, formic acid and organic SH-comprising compounds, such as 2-mercaptoethanol, 2-mercaptopropanol, mercaptoacetic acid, tert-butyl mercaptan or n-dodecyl mercaptan. Polymerization regulators are generally used in amounts of from 0.1 to 10% by weight, based on the total mass of the comonomers used. Preferably, no regulators are used.

One or more polymerization inhibitors may be added in small amounts during the copolymerization, for example hydroquinone monomethyl ether. Polymerization inhibitor can advantageously be metered with (B) and, if appropriate, (C). Suitable amounts of polymerization inhibitor are from 0.01 to 1, preferably from 0.05 to 0.5, % by weight, based on the mass of all comonomers. The addition of polymerization inhibitor is particularly preferred when the copolymerization is carried out at above 80° C.

After the end of the addition of (A) and (B), if appropriate (C), if appropriate (D) and, if appropriate, initiator, the reaction may be allowed to continue.

The duration of the free radical copolymerization is in general from 1 to 12, preferably from 2 to 9, particularly preferably from 3 to 6, hours. The duration of the reaction with (D) may be from 1 to 12, preferably from 2 to 9, particularly preferably from 3 to 6, hours.

If the novel preparation process is carried out in such a way that (A), (B) and, if appropriate, (C) are copolymerized in the presence of the total amount of (D), a suitable total duration of reaction is, for example, from 1 to 12, preferably from 2 to 10, particularly preferably from 3 to 8, hours.

The reaction with (D) can be carried out in the absence or presence of catalysts, in particular acidic catalysts, e.g. sulfuric acid, methanesulfonic acid, p-toluenesulfonic acid, n-dodecylbenzenesulfonic acid, hydrochloric acid or acidic ion exchangers.

If the reaction with (D) is carried out in the presence of catalysts, the duration of the reaction may be from 0.5 to 2 hours.

In a further variant of the process described, the reaction with (D) is carried out in the presence of an entraining agent which forms an azeotrope with water which may be formed during the reaction.

Under the conditions of the steps described above, (D) generally reacts completely or partly with the carboxyl groups of the anhydrides (A) and, if appropriate, with the carboxyl groups from (C). In general, less than 40 mol % remain behind as unconverted (D).

It is possible, by methods known per se, such as extraction, to separate unconverted (D) from copolymer obtainable by the novel preparation process.

In an embodiment, it is possible to dispense with the further step of separating unreacted (D) from the copolymers prepared according to the invention. In this embodiment, polymers are used together with a certain percentage of unreacted (D) for the treatment of fibrous substrates.

Copolymers are obtained by the copolymerization described above. The resulting copolymers can be subjected to a purification by conventional methods, for example reprecipitation or extractive removal of unconverted monomers. If a solvent or precipitating agent is used, it is possible to remove this after the end of the copolymerization, for example by distilling off.

For the purposes of the present invention, water is added to copolymer prepared as described above, the amount of added water being calculated so as to give novel dispersions which have a water content of from 30 to 99.5% by weight, based on the total mass of novel dispersion.

In an embodiment of the present invention, water is added after the free radical copolymerization and, if appropriate, the reaction with (D), it also being possible for the water to comprise Brøonsted acid or preferably Brøonsted base. Examples of Brøonsted acids are sulfuric acid, hydrochloric acid, tartaric acid and citric acid. Examples of Brøonsted base are alkali metal hydroxide, such as NaOH and KOH, alkali metal carbonate, such as Na₂CO₃ and K₂CO₃, alkali metal bicarbonate, such as NaHCO₃ and KHCO₃, ammonia and amines, such as trimethylamine, triethylamine, diethylamine, ethanolamine, N,N-diethanolamine, N,N,N-triethanolamine or N-methylethanolamine. The concentration of Brøonsted acid or preferably Brøonsted base is in general from 1 to 20% by weight, based on the sum of water and Brøonsted acid or water and Brøonsted base.

Water may be added during the free radical copolymerization itself, but water is preferably not added until toward the end of the free radical copolymerization. If the free radical copolymerization and the reaction with (D) have been carried out in the presence of solvent, it is preferable first to remove the solvent, for example by distilling off, and only thereafter to add water.

In a special embodiment of the present invention, the solvent is removed after the reaction with water by, for example, steam distillation.

By adding water, which, if appropriate, may comprise Brøonsted acid or preferably Brøonsted base, some or all of the carboxylic anhydride groups present in the copolymer can be hydrolyzed.

After the addition of water, which, if appropriate, may comprise Brøonsted acid or preferably Brøonsted base, the reaction may be allowed to continue at from 20 to 100° C., preferably up to 90° C., for a period of from 10 minutes to 4 hours.

In an embodiment of the present invention, water, which may also comprise Brøonsted acid or preferably Brøonsted base, is initially taken at from 50 to 100° C. and copolymer which, if appropriate, has been heated to 50 to 100° C. is added by a feed method.

In a further embodiment of the present invention, copolymer is initially taken at from 50 to 100° C., and water which, if appropriate, has been heated to 50 to 100° C. is added by a feed method, it being possible for the water also to comprise Brøonsted acid or preferably Brøonsted base.

In an embodiment of the present invention, a mixture of water which may also comprise Brøonsted acid or preferably Brøonsted base, and nonionic surfactant is initially taken at from 50 to 100° C. and copolymer which, if appropriate, has heated to 50 to 100° C. is added by a feed method. Examples of suitable nonionic surfactants are polyalkoxylated C₁₂-C₃₀-alkanols, preferably C₁₂-C₃₀-alkanols having a degree of alkoxylation of from 3 to 30.

In a further embodiment of the present invention, copolymer is initially taken at from 50 to 100° C. and the mixture of water, which may also comprise Brøonsted acid or preferably Brøonsted base, and nonionic surfactant is added by a feed method, said mixture being heated, if appropriate, to 50 to 100° C. An example of a suitable nonionic surfactant is polyalkoxylated C₁₂-C₃₀-alkanol, preferably C₁₂-C₃₀-alkanol having a degree of alkoxylation of from 3 to 30.

The present invention furthermore relates to the use of novel aqueous dispersions for the treatment of fibrous substrates. The present invention furthermore relates to a process for the treatment of fibrous substrates, also referred to below as novel treatment process, using novel aqueous dispersions.

In the context of the present invention, examples of fibrous substrates are:
textile, which, in the context of the present invention, is to be understood as meaning textile fibers, textile sheet-like structures, textile semifinished and finished products and finished goods produced therefrom, which, in addition to textiles for the clothing industry, also include, for example, carpets and other home textiles and textile structures serving technical purposes. These also include unshaped structures, for example flocks, linear structures, such as strings, threads, yams, lines, cords, ropes and twists, and three-dimensional structures, such as felts, woven fabrics, nonwovens and wadding. Textiles may be of natural origin, for example wool, flax or in particular cotton, or synthetic, for example polyamide and polyester;
paper, board and cardboard boxes;
wood and wood composites, for example particle boards;
artificial leather, alcantara or lefa, i.e. leather fiber materials from leather wastes which are processed with a binder or resin to give a synthetically produced fiber structure
   and particularly preferably
leather, which is to be understood as meaning animal hides pretanned and preferably tanned with the aid of optionally chrome tanning agents, mineral tanning agents, polymer tanning agents, synthetic tanning agents, vegetable tanning agents, resin tanning agents or combinations of at least two of the abovementioned tanning agents.

In an embodiment of the present invention, leather is animal hide (wet blue) or semifinished product tanned with the aid of chrome tanning agents.

In a preferred embodiment of the present invention, leather is animal hide (wet white) or semifinished product tanned without chromium.

Novel dispersions can be used in the tanning and preferably in the retanning, referred to below as novel tanning process and novel retanning process, respectively. Novel dispersions can be used in a separate treatment step.

The novel tanning process is carried out in general in such a way that novel dispersion or novel copolymer is added in one portion or in a plurality of portions immediately before or during the tanning. The novel tanning process is preferably carried out at a pH of from 2.5 to 8, preferably from 3 to 5.5, it frequently being observed that the pH increases by about 0.3 to three units while the novel tanning process is being carried out.

In an embodiment of the present invention, the pH can be increased by about 0.3 to three units by adding basifying agents.

In another embodiment of the present invention, the novel tanning process can be started at a pH of from 4 to 8 and novel copolymer can be fixed by adding an acidic component, for example formic acid, at a pH of from 3 to 5.5.

The novel tanning process is carried out in general at from 10 to 45° C., preferably from 20 to 30° C. A duration of from 10 minutes to 12 hours, preferably from one to three hours, has proven useful. The novel tanning process can be carried out in any desired vessels customary in tanneries, for example by drumming in barrels or in rotated drums.

In a variant of the novel tanning process, novel dispersion or novel copolymer is used together with one or more conventional tanning agents, for example with chrome tanning agents, mineral tanning agents, preferably with syntans, polymer tanning agents or vegetable tanning agents, as described, for example, in Ullmann's Encyclopedia of Industrial Chemistry, Volume A15, pages 259 to 282 and in particular page 268 et seq., 5th Edition (1990), Verlag Chemie Weinheim.

In a variant of the novel tanning process, novel dispersion or novel copolymer is used together with fatliquoring agents, such as natural triglycerides, white oil, paraffin, wax, silicone oil and furthermore emulsifiers.

In a variant of the novel tanning process, novel dispersion or novel copolymer is used together with conventional tanning agents and fatliquoring agents, but without silicone oil.

In the novel tanning process, it is possible to use from 0.5 to 40, preferably from 2 to 20, % by weight, based on the pelt weight, of novel dispersion or novel copolymer.

The novel process for the treatment of leather can preferably be carried out as a process for the retanning of leather using novel dispersion or novel copolymer. The novel retanning process starts from semifinished products tanned conventionally, i.e. for example with chrome tanning agents, mineral tanning agents based on Al, Ti, Zr, Fe and Si, preferably with polymer tanning agents, aldehydes, vegetable tanning agents, syntans or resin tanning agents, or semifinished products produced according to the invention as described above. For carrying out the novel retanning, novel copolymer is allowed to act on semifinished products.

The novel retanning process can be carried out under otherwise conventional conditions. One or more, i.e. from 2 to 6, soaking steps are expediently chosen and washing with water can be effected between the soaking steps. The temperature during the individual soaking steps is in each case from 5 to 60° C., preferably from 20 to 45° C.

In the novel retanning process, it is possible to use from 0.5 to 40, preferably from 2 to 20, % by weight, based on the shaved weight, of novel dispersion or novel copolymer.

Of course, compositions usually used during the retanning, for example fatliquors, polymer tanning agents, fatliquoring agents based on acrylate and/or methacrylate or based on silicones, retanning agents based on resin and vegetable tanning agents, fillers, leather dyes or emulsifiers or combinations of at least 2 of the abovementioned substances, can be added to the novel dispersion or novel copolymer in the novel tanning process or retanning process.

In an embodiment of the present invention, the novel treatment process and preferably the novel retanning process are carried out using at least one oligomer of branched or straight-chain C₃-C₁₀-alkene having an average molecular weight Mₙ of from 300 to 5 000 g/mol or using an oligomer which is obtainable by oligomerization of at least 3. equivalents of C₃-C₁₀-alkene. Preferably, at least one oligomer corresponds to the comonomer (B) used for the preparation of novel dispersion or novel copolymer. The ratio of polymerized (B) to additional oligomer may be from 1:0.1 to 1:10.

In an embodiment of the present invention, the novel retanning process is carried out in the presence of an emulsifier, for example in the presence of nonionic emulsifiers, such as polyalkoxylated C₇-C₃₀-alkanols, preferably C₇-C₃₀-alkanols having a degree of alkoxylation of from 3 to 30. If it is desired to use an emulsifier, for example, from 1 to 30% by weight, based on novel copolymer, of emulsifier can be used.

In an embodiment of the present invention, the addition of water repellents or fatliquoring agents based on silicones is dispensed with in the novel retanning process.

By means of the novel treatment, a fibrous substrate is rendered water repellent or is fatliquored.

The present invention furthermore relates to fibrous substrates, preferably leathers, for example leather based on wet-white or wet-blue and particularly preferably leather based on wet-white, produced by the novel treatment process. They have a particularly pleasant handle.

A further aspect of the present invention comprises leather produced by the novel tanning process or the novel retanning process or by a combination of novel tanning process and novel retanning process. The novel leathers have-a generally advantageous quality, for example a particularly pleasant handle, and are very soft and full. The novel leathers comprise a copolymer described above, which has penetrated particularly well in micro-regions of the elementary fibers.

A further aspect of the present invention comprises the use of novel leathers, for example novel leathers based on wet-white or wet-blue, preferably novel leathers based on wet-white and in particular novel leathers based on wet-white which were produced using vegetable tanning agents, for the production of articles of clothing, pieces of furniture or automotive parts. A further aspect of the present invention comprises a process for the production of articles of clothing, pieces of furniture or automotive parts using novel leathers, for example novel leathers based on wet-white or wet-blue, preferably novel leathers based on wet-white. In the context of the present invention, articles of clothing include, for example, jackets, pants, shoes, in particular shoe soles, belts or suspenders. In association with the present invention, pieces of furniture include all those pieces of furniture which comprise leather components, for example as a seat surface or on arm rests. Examples are seating furniture, such as seats, chairs and sofas. Examples of automotive parts are automobile seats.

A further aspect of the present invention comprises articles of clothing comprising the novel leather or produced from novel leather. A further aspect of the present invention comprises furniture comprising the novel leathers or produced from novel leathers. A further aspect of the invention comprises automotive parts comprising the novel leathers or produced from novel leathers.

The present invention furthermore relates to copolymers obtainable by free radical copolymerization of
(A) at least one ethylenically unsaturated dicarboxylic anhydride, derived from at least one dicarboxylic acid of 4 to 8 carbon atoms,
(B) at least one oligomer of branched or straight-chain C₃-C₁₀-alkene, at least one oligomer having an average molecular weight Mₙ of from 300 to 5 000 g/mol and being obtainable by oligomerization of at least 3 equivalents of C₃-C₁₀-alkene,
(C) optionally at least one ethylenically unsaturated comonomer differing from (A),
   and reaction with
(D) at least one compound of the formula I a or I b 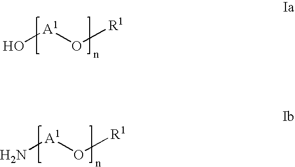
   where, in formulae I a and I b,
A¹ are identical or different C₂-C₂₀-alkylene,
R¹ is linear or branched C₁-C₃₀-alkyl, phenyl or hydrogen, and
n is an integer from 1 to 200.

The groups A¹ can of course be different only when n is greater than 1 or when different compounds of the formula I a and/or I b are used.

In an embodiment of the present invention, mixtures of different components (D), for example of the formula I a, are used. In particular, those mixtures of compounds of the formula I a in which—based in each case on the mixture—at least 95, preferably at least 98, mol % to not more than 99.8 mol % of R¹ are C₁-C₃₀-alkyl and at least 0.2 mol % and not more than 5, preferably not more than 2, mol % are hydrogen can be used.

In an embodiment of the present invention, novel copolymers or dicarboxylic anhydrides (A) incorporated as polymerized units in novel copolymers are present partly or completely in hydrolyzed and, if appropriate, neutralized form.

In an embodiment of the present invention, novel copolymers comprise at least one comonomer (C) in the form of polymerized units, which is selected from

ethylenically unsaturated C₃-C₈-carboxylic acid derivatives of the formula II 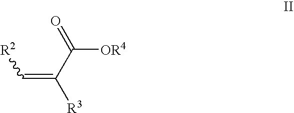
carboxamides of the formula III 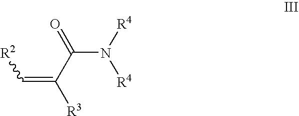
acyclic amides of the formula IV a or cyclic amides of the formula IV b

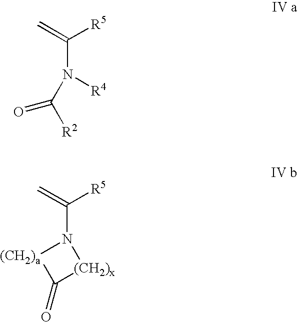

C₁-C₂₀-alkyl vinyl ethers;

N-vinyl derivatives of nitrogen-containing aromatic compounds;

α, β-unsaturated nitriles;
alkoxylated unsaturated ethers of the formula V 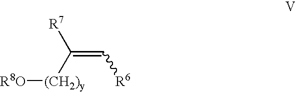
esters or amides of the formula VI 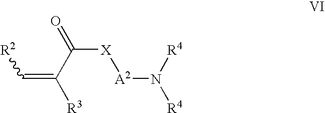
unsaturated esters of the formula VII 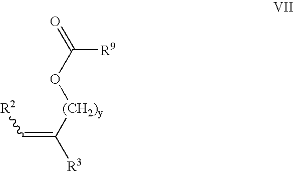
comonomers containing phosphate, phosphonate, sulfate and sulfonate groups;

linear or branched α-olefins of 3 to 40, preferably 4 to 24, carbon atoms, in particular isobutene, diisobutene, 1-decene, 1-dodecene, 1-octadecene, 1-eicosane, a-C₂₂H₄₄, α-C₂₄H₄₈ and mixtures of the abovementioned α-olefins;
vinylaromatic compounds of the formula VIII 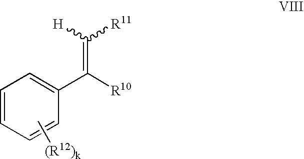
where, in the formulae,
A² and A³ are identical or different and are C₂-C₂₀-alkylene,
R² and R³ are identical or different and are selected from hydrogen, straight-chain or branched C₁-C₅-alkyl and COOR⁴,
R⁴ are identical or different and are selected from hydrogen and branched or straight-chain C₁-C22-alkyl,
R⁵ is hydrogen or methyl,
x is an integer from 2 to 6,
y is an integer selected from 0 and 1,
a is an integer from 0 to 6,
b is an integer from 1 to 200,
R⁶ and R⁷ are identical or different and are selected from hydrogen and straight-chain or branched C₁-C₁₀-alkyl,
X is oxygen or N-R⁴
R⁸ is [A³-O]_{b}-R^{4,}
R⁹ are identical or different and are selected from hydrogen and straight-chain or branched C₁-C₁₀-alkyl,
R₁₀and R₁₁, independently of one another, are hydrogen, methyl or ethyl,
R¹² is selected from methyl and ethyl,
k is an integer from 0 to 2
   and the remaining variables are defined as above.

In an embodiment of the present invention, the molar ratios of comonomer incorporated as polymerized units in the novel copolymer are as follows:
(A) from 5 to 60, preferably from 10 to 55, mol %,
(B) from 1 to 95, preferably from 10 to 60, mol %,
(C) from 0 to 70, preferably from 1 to 50, mol %, based in each case on novel copolymer, the sum of (A), (B) and (C) being 100 mol %, and
(D) from 1 to 50, preferably from 1 to 30, particularly preferably from 2 to 20, mol %, based on all carboxyl groups of the novel copolymer.

In an embodiment of the present invention, novel copolymers have an average molar mass Mₙ of from 1 000 to 50 000, preferably from 1 100 to 25 000, g/mol, determined, for example, by gel permeation chromatography using, for example, tetrahydrofuran or dimethylacetamide as a solvent and polymethyl methacrylate or polystyrene as a standard.

In relation to (A), (B) and, if appropriate, (C), novel copolymers can be block copolymers, alternating copolymers or random copolymers, alternating copolymers being preferred.

The polydispersity M_{w}/Mₙ, of novel copolymers is in general from 1.1 to 20, preferably from 1.5 to 10.

The present invention furthermore relates to a process for the preparation of novel copolymers.

The present invention furthermore relates to a process for the preparation of novel aqueous dispersions, also referred to below as novel preparation process.

For carrying out the novel preparation process, (A), (B) and, if appropriate, (C) are used as starting materials and are subjected to free radical copolymerization with one another and reacted with (D). The reaction with (D) can be carried out before, during or after the copolymerization.

In an embodiment of the present invention, hydrolysis with water is effected after the free radical copolymerization and the reaction with (D), it also being possible for the water to comprise Brøonsted acid or preferably Brøonsted base. Examples of Brøonsted acids are sulfuric acid, hydrochloric acid, tartaric acid and citric acid. Examples of Brøonsted bases are alkali metal hydroxide, such as NaOH and KOH, alkali metal carbonate, such as Na₂CO₃ and K₂CO₃, alkali metal bicarbonate, such as NaHCO₃ and KHCO₃, ammonia and amines, such as trimethylamine, triethylamine, diethylamine, ethanolamine, N,N-diethanolamine, N,N,N-triethanolamine or N-methylethanolamine.

Novel copolymers are usually obtained in the form of aqueous dispersions or aqueous solutions or as such. Novel copolymers can be isolated from novel aqueous dispersions by methods known per se to a person skilled in the art, for example by evaporating water or by spray-drying.

A further aspect of the present invention comprises the use of novel copolymer for the treatment of fibrous substrates.

The present invention furthermore relates to the use of novel aqueous dispersions or of novel copolymers for the impregnation of sheet-like substrates. The present invention furthermore relates to a process for the impregnation of sheet-like substrates using novel dispersions or novel copolymer, also referred to below as novel impregnation process. The novel impregnation process can be carried out, for example, by treating sheet-like substrates with at least one novel aqueous dispersion or at least one novel copolymer.

In the context of the present invention, sheet-like substrates may be, for example, concrete or bricks.

The working examples which follow illustrate the invention.

1. Synthesis Method for Copolymerization and Esterification

All reactions were carried out under a nitrogen atmosphere, unless stated otherwise.

The average molar mass M_{w}, of the novel copolymers was determined by the size exclusion chromatography method using dimethylacetamide as a solvent and polymethyl methacrylate as a standard.

1.1. General Preparation Method for Mass Copolymerization and Esterification

Comonomers (B) and, if appropriate, (C) according to table 1 were initially taken in a 2 l kettle and heated to 150° C. in a gentle stream of nitrogen. After this temperature had been reached, the monomer (A) was metered in in the course of 5 hours in liquid form as a melt at about 70° C. and, if appropriate, (C) according to table 1, and the stated amount of di-tert-butyl peroxide was metered in in the course of 5.5 hours. The method of addition of comonomer (C) or comonomers (C) added if appropriate is shown in table 1. Heating was then continued for one hour at 150° C.

If appropriate, (D) was then added. In the experiments in which (D) was added, the resulting mixture was heated under nitrogen for three hours to 150° C.

The resulting reaction mixture was then further processed in each case to give a novel dispersion.

The resulting reaction mixture was cooled to 90° C., and aqueous sodium hydroxide was added, the molar NaOH/maleic anhydride ratio being in each case 0.6:1.0. Thereafter, stirring was carried out for 4 hours at 90° C. and cooling to room temperature was then effected. Novel dispersions which each had a pH of from 5.5 to 6.5 were obtained.

Further details of the preparation of novel dispersions are shown in table 1.

1.2. Preparation Method for Dispersion, Comprising Copolymer 13

245 g (2.5 mol) of maleic anhydride were initially taken in 400 g of o-xylene in a 2 l kettle having a dry ice cooler and heated to 120° C. in a gentle stream of nitrogen. After this temperature has been reached, 250 g (0.25 mol) of oligoisobutene (M_{w}=1 000 g/mol) are metered in in the course of 3 hours, 140 g (2.5 mol) of isobutene in the course of 5 hours and 10.4 g of tert-butyl peroctanoate in the course of 5.5 hours. Heating was then continued at 120° C. for 1 hour. After cooling to 90° C., 660 g of water were added and the o-xylene was removed by steam distillation. The resulting reaction mixture was cooled to 60° C., and 400 g of 25% strength sodium hydroxide solution were added. Thereafter, stirring was effected for 1 hour at 60° C., followed by cooling to room temperature. Dispersion 13 according to the invention was obtained. Dispersion 13 according to the invention had a pH of 6.9 and a water content of 74%. M_{w}−10 000

TABLE 1
Preparation of novel dispersions

| | Maleic | Oligo- | Further | | | | | M_{w} of | | Water |
|---|---|---|---|---|---|---|---|---|---|---|
| Dispersion | anhydride | isobutene | comonomer(s) | Method | Component | Addition of | Perox- | copoly- | | content of |
| comprising | (A) | (B) | (C) | of | (D) | aqueous | ide | mer | | dispersion |
| copolymer | (mol) | [g (mol)] | [g (mol)] | addition | [g (mol)] | NaOH [ml] | [g] | [g/mol] | pH | [% by wt.] |
| 1 | 98 | [M_{w}] = 550 | — | — | — | 2000 | 13.0 | 1120 | 5.9 | 74.7 |
| | (1.00) | 550 (1.00) | | | | | | | | |
| 2 | 98 | [M_{w}] = 550 | — | — | D1 | 3500 | 13.0 | 1550 | 5.9 | 77.0 |
| | (1.00) | 550 (1.00) | | | 500 (1.00) | | | | | |
| 3 | 39 | [M_{w}] = 550 | — | — | D1 | 2600 | 5.2 | 1400 | 5.8 | 77.3 |
| | (0.40) | 550 (1.00) | | | 175 (0.35) | | | | | |
| 4 | 20 | [M_{w}] = 550 | — | — | D1 | 2100 | 2.7 | 1390 | 6.0 | 75.8 |
| | (0.20) | 550 (1.00) | | | 90 (0.18) | | | | | |
| 5 | 98 | [M_{w}] = 550 | 1-Dodecene | Initially | — | 1000 | 3.4 | 8700 | 5.9 | 75.0 |
| | (1.00) | 110 (0.2) | 134 (0.80) | taken | | | | | | |
| 6 | 98 | [M_{w}] = 1000 | 1-Dodecene | Initially | — | 1200 | 7.0 | 10500 | 5.9 | 77.2 |
| | (1.00) | 100 (0.1) | 151 (0.90) | taken | | | | | | |
| 7 | 98 | [M_{w}] = 550 | α-C₂₀₋₂₄-Olefin | Initially | — | 1650 | 9.9 | 3250 | 5.9 | 76.5 |
| | (1.00) | 220 (0.4) | 178 (0.60) | taken | | | | | | |
| 8 | 98 | [M_{w}] = 550 | α-C₂₀₋₂₄-Olefin | Initially | D1 | 1600 | 9.9 | 4020 | 5.7 | 76.1 |
| | (1.00) | 220 (0.4) | 178 (0.60) | taken | 75 (0.15) | | | | | |
| 9 | 98 | [M_{w}] = 550 | 1-Dodecene | Initially | D2 | 1800 | 6.0 | 4880 | 5.8 | 75.2 |
| | (1.00) | 220 (0.4) | 100 (0.60) | taken | 161 (0.30) | | | | | |
| 10 | 98 | [M_{w}] = 1000 | Acrylic acid | Feed | — | 2200 | 7.0 | 9800 | 5.8 | 76.4 |
| | (1.00) | 500 (0.50) | 72 (1.00) | | | | | | | |
| 11 | 98 | [M_{w}] = 550 | 1-Dodecene | Initially | — | 1000 | 3.5 | 10050 | 5.9 | 75.5 |
| | (1.00) | 110 (0.2) | 84 (0.50) | taken | | | | | | |
| | | | Styrene | Feed | | | | | | |
| | | | 31 (0.30) | | | | | | | |
| 12 | 98 | [M_{w}] = 550 | 1-Dodecene | Initially | D1 | 1500 | 3.5 | 12100 | 5.6 | 76.1 |
| | (1.00) | 110 (0.2) | 84 (0.50) | taken | 150 (0.30) | | | | | |
| | | | Styrene | Feed | | | | | | |
| | | | 31 (0.30) | | | | | | | |

D1: Polyethylene glycol monomethyl ether having an average molecular weight Mₙ of 500 g/mol
D2: n-C₁₅H₃₁—O—(CH₂—CH₂—O)₇—H
Data on [M_{w}] are in g/mol

2. Testing of Performance Characteristics

The data in % by weight are based in each case on the shaved weight, unless stated otherwise.

2.1 Use in the Retanning of Leather—Production of Upper Leather

Two commercial cattle wet-blues (from Packer, USA) were shaved to a thickness of 1.8-2.0 mm and cut into eight strips of about 1 000 g each. 2% by weight of sodium formate and 0.4% by weight of NaHCO₃ and 1% by weight of a naphthalenesulfonic acid/formaldehyde condensate, prepared according to US 5,186,846, example entitled “Dispersant 1”, were then added to the strips in a drum (50 l) and with a liquor length of 200% by weight with an interval of 10 minutes. After 90 minutes, the liquor was discharged. The strips were then distributed over 7 separate drums for drumming.

Together with 100% by weight of water, 1% by weight each of a 50% strength by weight (solids content) aqueous solution of dyes, whose solids had the following composition, was metered into drums 1 to 7 at from 25 to 35° C.:

70 parts by weight of dye from EP-B 0 970 148, example 2.18,

30 parts by weight of Acid Brown 75 (iron complex), Colour Index 1.7.16,

and drumming was effected for 10 minutes.

Thereafter, as stated in table 2, 6% by weight each of novel dispersion according to table 1 were added and the mixtures were drummed for 30 minutes. Thereafter, 8% by weight each of sulfone tanning agent from EP-B 0 459 168, example K1, were added and drumming was effected for a further 30 minutes at 15 rpm. The strips were then treated for 45 minutes with 3% by weight each of vegetable tanning agent Mimosa® and 1.5% each of the above-defined solution of dyes.

Acidification was then effected with formic acid to a pH of 3.6-3.8. After 20 minutes, the liquors were assessed for exhaustion by an optical procedure and were discharged. The novel leathers 2.1.1 to 2.1.7 were obtained. The novel leathers were then washed with 200% by weight of water. Finally, 2% by weight of a fatliquoring agent, which was prepared as described under 3., were metered into 100% of water at 50° C. After a drumming time of 45 minutes, acidification was effected with 1% by weight of formic acid.

The washed leathers were dried and staked.

The novel leathers 2.1.1 to 2.1.7 had excellent body, softness and handle in combination with outstanding dye penetration of the fibers. In addition, the leathers exhibit pronounced water repellency without having been treated with water repellent based on silicone compounds, the novel water repellency being capable of even surpassing the effect of silicone oils.

### COMPARATIVE EXAMPLE C1

For comparative example C1, the procedure was as above except that, instead of the copolymer, altogether 8% by weight of the fatliquoring agent from 3. were metered in two portions, the first 4% by weight of fatliquoring agent being metered together with Mimosa® and a solution of dyes, while the second 4% by weight were added, as above, after the first acidification.

TABLE 2
Testing of performance characteristics of novel leathers 2.1.1 to 2.1.7 and
comparative leather C1

| | | | | | Water | | |
|---|---|---|---|---|---|---|---|
| | | | | | absorption | Water | Level- |
| | Copolymer | | Grain | | 2 h¹ | penetration, | ness of |
| No. | (Tab. 1) | Body | tightness | Softness | [% by wt.] | dynamic² | dyeing |
| C1 | — | 3 | 3.5 | 3 | 62 | 26 | 3 |
| 2.1.1 | 2 | 3 | 3 | 3.5 | 49 | 180 | 2.5 |
| 2.1.2 | 5 | 1.5 | 2 | 1.5 | 11 | 42000 | 1.5 |
| 2.1.3 | 6 | 2 | 2 | 2 | 19 | 10500 | 2 |
| 2.1.4 | 7 | 3 | 2.5 | 3 | 38 | 1200 | 3 |
| 2.1.5 | 8 | 1 | 3 | 2 | 16 | 15000 | 2 |
| 2.1.6 | 10 | 2.5 | 3 | 3 | 43 | 240 | 3 |
| 2.1.7 | 12 | 2.5 | 2.5 | 1 | 40 | 400 | 1.5 |

Remarks:

The evaluation of body, grain tightness, softness and levelness of dyeing was effected according to a rating system from 1 (very good) to 5 (poor).
1: Determination of the water absorption according to Kubelka, based on DIN 53330 (5.78), Das Leder 12 (1961), 36-37, penetration time: 2 h
2: Determination of the behavior with respect to water under dynamic load, Maeser test according to ASTM D 2099,
   Das Leder 12 (1961), 3840, water penetration after number of flexes.

2.2 Examples: 2.2.1 to 2.2.7: Novel Retanning of Wet-white Semifinished Products

A southern German cattle hide was converted by a standard method into a corresponding wet-white semifinished product, shaved to a thickness of 1.8 mm and cut into strips of about 500 g each.

2% by weight of sodium formate and 0.4% by weight of NaHCO₃ and 1% by weight of a naphthalenesulfonic acid/formaldehyde condensate, prepared according to US 5,186,846, example entitled “Dispersant 1”, were added to the strips of the semifinished product in a drum (50l) and with a liquor length of 150% by weight with an interval of 10 minutes. After 90 minutes, the liquor was discharged. The strips were then distributed over 7 separate drums for drumming.

Thereafter, 10% by weight each of novel copolymer dispersion according to tables 1 and 3 and 8% by weight each of sulfone tanning agent from EP-B 0 459 168, example K1, were added and drumming was effected over a period of 45 minutes with the leather. 6% by weight of vegetable tanning agent Tara (BASF Aktiengesellschaft) and 2% by weight of a 50% strength by weight (solids content) aqueous solution of dyes, whose solids had the following composition, were then metered:

70 parts by weight of dye from EP-B 0 970 148, example 2.18,

30 parts by weight of Acid Brown 75 (iron complex), Colour Index 1.7.16,

and drumming was effected for a further 2 hours. After two hours, a pH of 3.6 was established with formic acid. Finally, 1.5% of Lipamin® OK were added in each case and acidification was effected with formic acid to pH 3.2 after a drumming time of a further 60 minutes. Novel leathers 2.2.1 to 2.2.7 were obtained.

The novel leathers were washed twice with 100% of water each time, stored moist ovemight, partly dried and then dried on a toggle frame at 50° C. After staking, the leathers were assessed as below.

The assessment was effected according to a rating system of 1 (very good) to 5 (poor). The assessment of the liquor exhaustion was effected visually according to the criteria of residual dye (extinction) and turbidity (fatliquoring agent).

In examples 2.2.6 and 2.2.7,1.5% by weight of silicone emulsion according to 4. (see below) were additionally metered before the metering of Lipamin® OK.

TABLE 3
Examples 2.2.1 to 2.2.7

| | | | | | Water | | |
|---|---|---|---|---|---|---|---|
| | Copoly- | | | | absorption* | Water pene- | Level- |
| | mer | | Grain | | 2 h | tration**, | ness of |
| No. | (Tab. 1) | Body | tightness | Softness | [% by wt.] | dynamic | dyeing |
| 2.2.1 | 12 | 2.5 | 3.5 | 2.5 | 58 | 120 | 2.5 |
| 2.2.2 | 5 | 2.5 | 2.5 | 1.5 | 19 | 18000 | 1.5 |
| 2.2.3 | 6 | 2 | 3 | 2 | 26 | 4300 | 2 |
| 2.2.4 | 7 | 3.5 | 2.5 | 3.5 | 46 | 180 | 3 |
| 2.2.5 | 8 | 1 | 2 | 2 | 34 | 7500 | 2 |
| 2.2.6 | 5 | 1.5 | 2.5 | 1 | 12.8 | 45000 | 1.5 |
| 2.2.7 | 8 | 2 | 1.5 | 1 | 20.5 | 22000 | 2 |

*according to DIN 53328
**according to ASTM D 2099

3. Preparation of a Fatliquoring Agent

The following were mixed in a 2 l kettle:

230 g of a polyisobutene having Mₙ=1 000 g/mol and Mₙ=1 800 g/mol

30 g of n-C₁₈H₃₇O—(CH₂CH₂O)₂₅—OH

5 g of n-C₁₈H₃₇O—(CH₂CH₂O)₈₀—OH

40 g of oleic acid

230 g of sulfited oxidized triolein

The mixture was heated to 60° C. with stirring, and 470 g of water and 10 g of n-C₁₆H₃₃O—(CH₂CH₂O)₇—OH were added. The resulting emulsion was then passed through a gap homogenizer. A finely divided, stable emulsion was obtained.

4. Preparation of a Silicone Emulsion

The following were mixed in a 2 l container having a stirrer: 150 g of a silicone, kinematic viscosity 600 mm²/s, of the formula 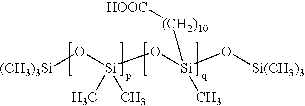
as a random cocondensate with q=3 and p=145 (average values in each case)

130 g of N-oleylsarcosine

15 g of NaOH (solid)

153 g of slack wax (36/38° C.; Shell)

450 ml of water

The resulting silicone emulsion had a pH of 8.5.

1. An aqueous dispersion of a copolymer obtained by free radical copolymerization of
(A) at least one ethylenically unsaturated dicarboxylic anhydride, derived from at least one dicarboxylic acid of 4 to 8 carbon atoms,
(B) at least one oligomer of isobutene, at least one oligomer having an average molecular weight Mₙ of from 300 to 5 000 g/mol,
(C) optionally at least one ethylenically unsaturated comonomer differing from (A),
and reaction with
(D) at least one compound of the formula I a or I b 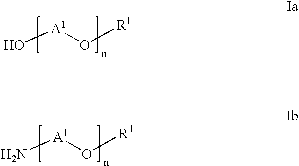
and subsequent addition of water,
wherein, in formulae I a and I b,
A¹ are identical or different C₂-C₂₀-alkylene,
R¹ are linear or branched C₁-C₃₀-alkyl, phenyl or hydrogen, and
n is an integer from 1 to 200,
the water content being from 30 to 99.5% by weight, based on aqueous dispersion.

2. The aqueous dispersion according to claim 1, wherein some or all of the anhydride group of the copolymer are hydrolyzed with water or an aqueous alkaline solution after the polymerization.

3. The aqueous dispersion according to claim 1, wherein the molar ratios of comonomers incorporated in the form of polymerized units in the copolymer are as follows:
(A) from 5 to 60 mol %,
(B) from 1 to 95 mol %,
(C) from 0 to 70 mol %, based in each case on copolymer, the sum of (A), (B) and (C) being 100 mol %, and
(D) from 0 to 50 mol %, based on all carboxyl groups of the copolymer.

4. The aqueous dispersion according to claim 1, wherein (C) is selected from ethylenically unsaturated C₃-C₈-carboxylic acid derivatives of the formula II 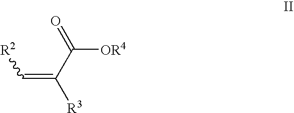
carboxamides of the formula III 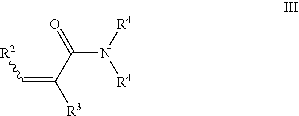
acyclic amides of the formula IV a or cyclic amides of the formula IV b 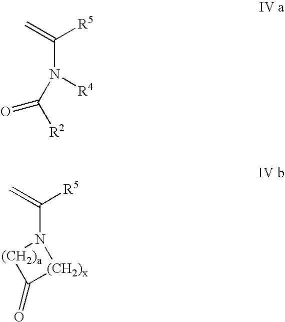
C₁-C₂₀-alkyl vinyl ethers,
N-vinyl derivatives of nitrogen-containing aromatic compounds,
α, β-unsaturated nitriles,
alkoxylated unsaturated ethers of the formula V 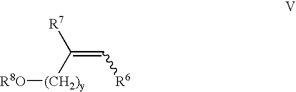
esters or amides of the formula VI 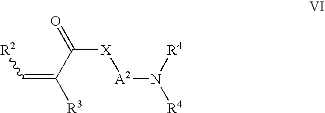
unsaturated esters of the formula VII 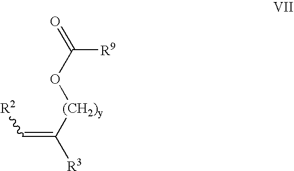
comonomers containing phosphate, phosphonate, sulfate and sulfonate groups,
α-olefins of 3 to 40 carbon atoms,
vinylaromatic compounds of the formula VIII 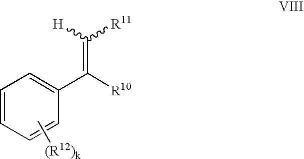
where, in the formulae,
A² and A³ are identical or different and are C₂-C₂₀-alkylene,
R² and R³ are identical or different and are selected from hydrogen, straight-chain or branched C₁-C₅-alkyl and COOR⁴,
R⁴ are identical or different and are selected from hydrogen and branched or straight-chain C₁-C₂₂-alkyl,
R⁵ is hydrogen or methyl,
x is an integer from 2 to 6,
y is an integer selected from 0 and 1,
a is an integer from 0 to 6,
b is an integer from 1 to 200,
R⁶ and R⁷ are identical or different and are selected from hydrogen and straight-chain or branched C₁-C₁₀-alkyl,
x is oxygen or N-R⁴
R⁸ is [A³-O]_{b}—R⁴,
R⁹ are identical or different and are selected from hydrogen and straight-chain or branched C₁-C₁₀-alkyl,
R¹⁰ and R¹¹, independently of one another, are hydrogen, methyl or ethyl,
R¹² is selected from methyl and ethyl,
k is an integer from 0 to 2
and the remaining variables are defined as above.

5. The aqueous dispersion according to claim 1, which comprises at least one oligomer of isobutene, at least one oligomer having an average molecular weight Mₙ of from 300 to 5 000 g/mol.

6. A process for the preparation of an aqueous dispersion according to claim 1, wherein (B) and (C) are initially taken, initiator and (A) are added by a feed method, (A), (B) and (C) are subjected to free radical copolymerization with one another, then reacted with (D) and then water is added.

7. The process according to claim 6, wherein reaction with (D) is effected during or after the copolymerization of (A), (B) and, if required, (C) with (D).

8. The use of an aqueous dispersion according to claim 1 for the treatment of fibrous substrates.

9. A process for the treatment of fibrous substrates using an aqueous dispersion according to claim 1.

10. The process according to claim 9, wherein fibrous substrates are selected from leather, textile, paper, board, wood, wood composites, artificial leather, alcantara and lefa.

11. The process according to claim 10, wherein the leather is wet-white.

12. A fibrous substrate treated by a process according to claim 9.

13. The fibrous substrate according to claim 12, wherein said substrate is leather.

14. The leather according to claim 13, wherein said leather is based on wet-white.

15. The use of a fibrous substrate according to claim 12 for the production of articles of clothing or pieces of furniture or automotive parts.

16. A copolymer obtainable by free radical copolymerization of
(A) at least one ethylenically unsaturated dicarboxylic anhydride, derived from at least one dicarboxylic acid of 4 to 8 carbon atoms,
(B) at least one oligomer of isobutene, at least one oligomer having an average molecular weight Mₙ of from 300 to 5 000 g/mol,
(C) optionally at least one ethylenically unsaturated comonomer differing from (A),
and reaction with
(D) at least one compound of the formula I a or I b 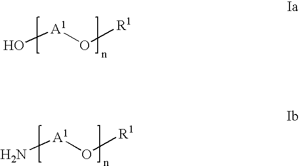
where, in formulae I a and I b,
A¹ are identical or different C₂-C₂₀-alkylene,
R¹ is linear or branched C₁-C₃₀-alkyl, phenyl or hydrogen, and
n is an integer from 1 to 200,
and optionally hydrolysis.

17. The copolymer according to claim 16, wherein (C) is selected from ethylenically unsaturated C₃-C₈-carboxylic acid derivatives of the formula II 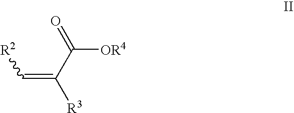
carboxamides of the formula III 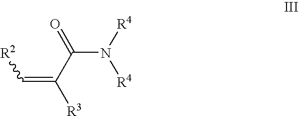
acyclic amides of the formula IV a or cyclic amides of the formula IV b 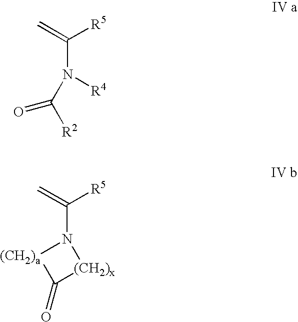
C₁-C₂-alkyl vinyl ethers,
N-vinyl derivatives of nitrogen-containing aromatic compounds,
α,β-unsaturated nitriles,
alkoxylated unsaturated ethers of the formula V 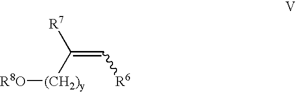
esters or amides of the formula VI 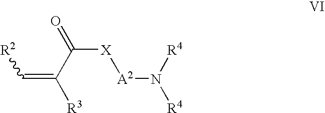
unsaturated esters of the formula VII 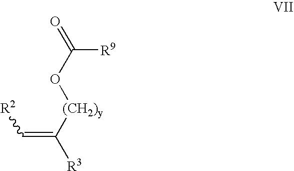
comonomers containing phosphate, phosphonate, sulfate and sulfonate groups,
α-olefins of 3 to 40 carbon atoms,
vinylaromatic compounds of the formula VIII 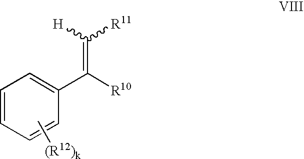
where, in the formulae,
A² and A³ are identical or different and are C₂-C₂₀-alkylene,
R² and R³ are identical or different and are selected from hydrogen, straight-chain or branched C₁-C₅-alkyl and COOR⁴,
R⁴ are identical or different and are selected from hydrogen and branched or straight-chain C₁-C₂₂-alkyl,
R⁵ is hydrogen or methyl,
x is an integer from 2 to 6,
y is an integer selected from 0 and 1,
a is an integer from 0 to 6,
b is an integer from 1 to 200,
R⁶ and R⁷ are identical or different and are selected from hydrogen and straight-chain or branched C₁-C₁₀-alkyl,
X is oxygen or N-R⁴
R⁸ is [A³-O]_{b}—R⁴,
R⁹ are identical or different and are selected from hydrogen and straight-chain or branched C₁-C₁₀-alkyl,
R¹⁰ and R¹¹, independently of one another, are hydrogen, methyl or ethyl,
R¹² is selected from methyl and ethyl,
k is an integer from O to 2
and the remaining variables are defined as above.

18. The use of a copolymer according to claim 16 for the treatment of fibrous substrates.

19. The use of an aqueous dispersion according to claim 1 for the impregnation of sheet-like substrates.

20. A process for the impregnation of sheet-like substrates, wherein a sheet-like substrate is treated with an aqueous dispersion according to claim 2.

21. The process according to claim 20, wherein the sheet-like substrate is concrete or brick.
